(19) United States
(12) Patent Application Publication
(10) Pub. No.: US 2002/0088675 A1
(43) Pub. Date: Jul. 11, 2002

(54) Disc brake

(76) Inventor: Tim Yoko, South Bend, IN (US)

Correspondence Address: LEO H MCCORMICK, 2112 MISHAWAKA AVE, P O BOX 4721, SOUTH BEND, IN, 46634

(21) Appl. No.: 09/757,929

(22) Filed: Jan. 10, 2001

(51) Int. Cl. F16D 55/00; F16D 65/04

(52) U.S. Cl. 188/71.1; 188/250 R

(57) ABSTRACT

A disc brake (110) for use in a brake system of a vehicle. The disc brake (110) has a caliper (16) which retains first (130) and second (132) brake pad assemblies in alignment with corresponding first (134a) and second (134b) braking surfaces on a rotor (134). In response to hydraulic fluid being supplied to an actuation chamber (18) in the caliper (16), the first (130) and second (132) brake pad assemblies are moved into engagement with the first (134a) and second (134b) braking surfaces to retard the rotation of the rotor (134) and effect a brake application for the vehicle. The disc brake (110) is characterized by the first (134a) and second (134b) braking surfaces on the rotor (134) having a radial concave shape while the first and second friction member of the first (130) and second brake pad assemblies respectively have corresponding surfaces (131,133) with a radial convex shape. The radial convex shape being complementary to the radial concave shape such that on engagement during a brake application, the first (130) and second (132) brake pad assemblies are retained in a substantially uniform arcuate location® about an axis of rotation of the rotor (134).

This invention relates to a disc brake for use in a brake system wherein first and second brake pads each have a convex surface which engage a rotor which has complementary concave braking surfaces to effect a brake application.

### BACKGROUND OF THE INVENTION

Disc brakes of the spot-type wherein two support members which are spaced apart from each other with first and second friction pads slidably guided on the support during a brake application are known in the prior art, the following U.S. Pat. Nos. 4,044,864; 4,219,106; 4,225,017; 4,335,806; 4,567,968; 4,936,422; 5,515,951; and 5,551,537 may be considered to be typical of such disc brakes. In these disc brakes, first and second friction pads have a carrier members which are retained in first and second rails on an anchor to distribute frictional forces into a fixed support during a brake application. The leading edge of the friction pads is held in engagement with the fixed support or abutment and transfers forces into a fixed support however a trailing edge is free to move or vibrate and as a result noise may be produced during braking. Noise and/or squeal can be attenuated by structure disclosed in U.S. Pat. Nos. 5,111,914 and 5,558,805 wherein carriers members and rails having matched corresponding concave and convex surfaces through which brake forces are transmitted in a push and pull operation during a brake application. However, the distribution of the frictional forces in such disc brakes is dependent on dimensional tolerances of the carrier members and rails such that in practice it is difficult to manufacture disc brakes wherein equal distribution of the friction forces actually occurs through each rail.

### SUMMARY OF THE INVENTION

A primary object of the present invention is to provide a disc brake wherein noise developed by radial movement or vibration is reduced or eliminated during a brake application by restraining a trailing edge of friction pads through engagement with a corresponding braking surface on a rotor of a vehicle.

In more particular detail, the disc brake has a caliper with a bore therein which defines an actuation chamber for retaining an actuation piston. The center of the bore is located on a radius from a axle for a wheel of a vehicle and defines an effective radius for the disc brake. In this disc brake, a first brake pad is secured to the actuation piston and a second brake pad is secured to the caliper. The first and second brake pads being held in alignment with corresponding first and second braking surfaces on a rotor connected with the wheel of the vehicle. In response to hydraulic fluid being supplied to the actuation chamber in the caliper, the first and second brake pads move into engagement with the first and second braking surfaces to retard the rotation of the rotor and wheel to effect a brake application for the vehicle. The disc brake is characterized by the first and second braking surfaces on the rotor having a radial concave shape while the friction surfaces on the first and second brake pads have with a complementary radial convex shape. During a brake application, the radial convex shapes engage the radial concave shapes to prevent the first and second brake pads from radially moving and thereby retain the first and second brake pads in a substantially uniform arcuate location about an axis of rotation of the rotor.

An advantage of the disc brake results in a substantial reduction in the development of radial vibration since the entire engagement surface of each brake pads is radially retained by the contact engagement between concave and convex surfaces.

An object of this invention is to provide structure through which a entire friction surface of a brake pad for a disc brake is restrained in an radial plane defined by an effective radius of a rotor.

### BRIEF DESCRIPTION OF THE DRAWINGS

FIG. 1 is a schematic illustration of a relationship between a typical prior disc brake and rotor used in a brake system;

FIG. 2 is a sectional view taken along line 2-2 of FIG. 1;

FIG. 3 is a schematic illustration of a relationship between a brake pad assembly and support in the disc brake of FIG. 1 made according to the principals of the invention; and

FIG. 4 is view taken along line 4-4 of FIG. 3.

FIG. 5 is a segment of a disc brake showing an alternate engagement surface corresponding to the present invention.

### DETAILED DESCRIPTION

The disc brake 10 for a brake system as illustrated in FIG. 1 is known in the prior art and includes an anchor 12 which is fixed to the housing 14 of a vehicle, in a manner disclosed in U.S. Pat. No. 5,988,761. In disc brake 10, a caliper 16 is mounted to slide in response to pressurized fluid being supplied to an actuation chamber 18 defined in bore 20, see FIG. 2, to effect a brake application. Anchor 12 includes a first rail 22 with two spaced apart support members 24, only one is shown, and a second rail 26 with two spaced apart support members 28, only one is shown. The first 22 and second 26 rails guide and support corresponding first 30 and second 32 brake pad assembles which are located on opposite sides of a rotor 34. The first brake pad assembly 30 is connected to the caliper 16 while the second brake pad assembly 32 is connected to an actuation piston 36 located in bore 20. To effect a brake application, pressurized fluid is supplied to chamber 18 through port 25 in response to an operator desiring to make a brake application. The pressurized fluid in chamber 18 acts on a piston 36 to move brake pad assembly 32 into engagement a first braking surface 42 on rotor 34 and acts on caliper 16 to move brake pad assembly 30 into engagement with a second braking surface 40 on the rotor 34 to develop a corresponding brake force. The first 22 and second 26 rails hold the first 30 and second 32 brake pad assembles in a parallel relationship with rotor 34 such that the friction members associated with the first 30 and second 32 brake pad assembles uniformly contact the braking surfaces 40,42 on rotor 34 during a brake application. During a brake application, brake forces are equally transmitted by the leading edge 30a of friction member of brake pad assembly 30 and leading edge of friction member of brake pad assembly 32 into support member 24. In this situation, the leading edge 30a of friction member of brake pad assembly 30 and leading edge of friction member of brake pad assembly 32 are restrained in a fixed position by a squeezing force provided by the actuation piston 36 and in a resistive position by the braking force F which is carried into support member 28. These two forces are combined and hold the leading edges (only 30a is shown) in a substantially fixed position. Unfortunately, the trailing edge 30b of friction member of brake pad assembly 30 and trailing edge of friction member of brake pad assembly 32 are unrestrained and not in contact with support member 24. Since the surfaces of the friction members and braking surface on rotor 34 are parallel, radial movement, illustrated by arrows x-x in FIG. 1, may occur at the trailing edges (only 30b is shown). This structure functions in an adequate manner during most brake applications, however, under some circumstances the radial movement is sufficient to create vibration which can create noise and/or squeal during a brake application which is considered by some to be an undesirable operation characteristic.

The friction members and rotor for a disc brake 110, illustrated in FIGS. 3, 4 and 5, provides structure which substantially eliminates or at least attenuates radial vibration of the trailing edges of the friction members of brake pad assembles 30 and 32 illustrated in FIGS. 1 and 2. The structural components in FIGS. 3, 4 and 5 which are identical with a same component in FIGS. 1 and 2 have a same number and not further description is provided.

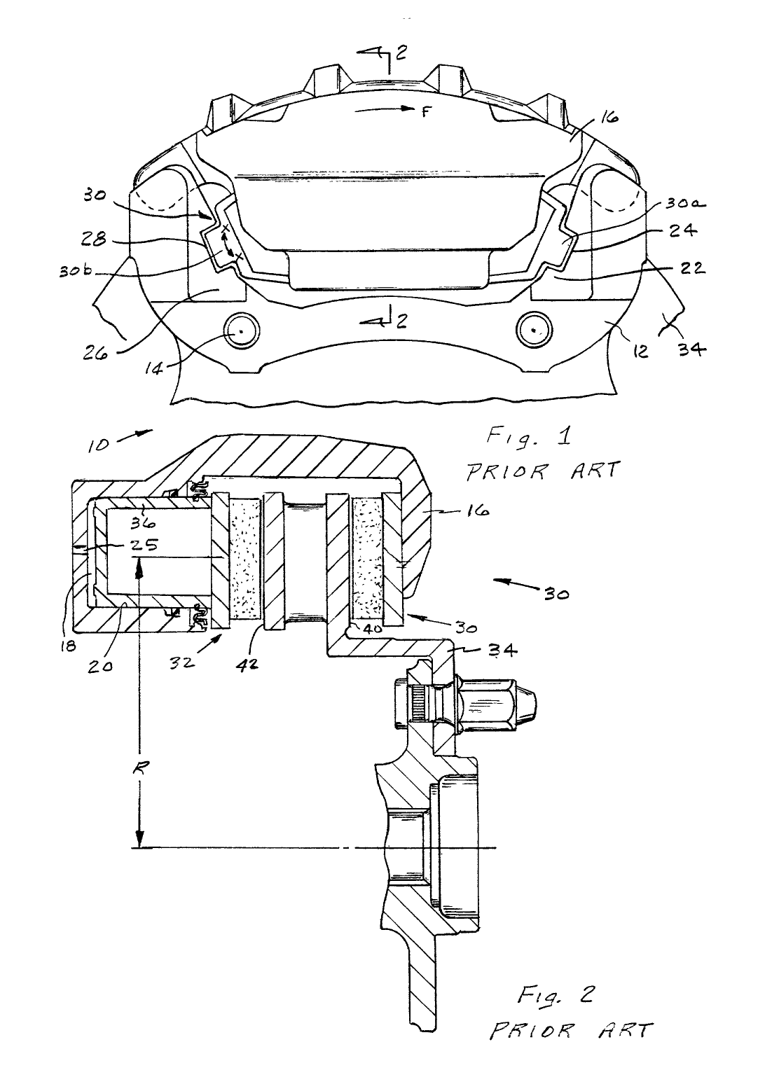

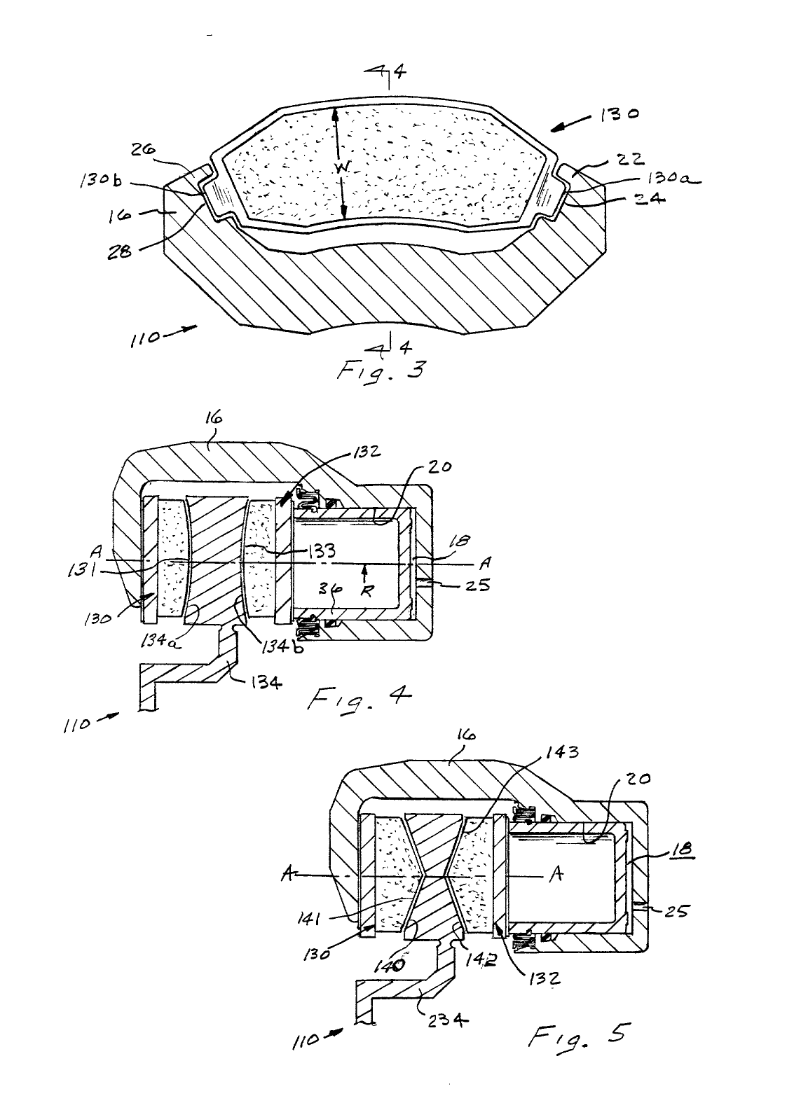

The disc brake 110 shown in FIGS. 3 and 4 is characterized by rotor 134 having braking surfaces 134a and 134b with a radial concave shape and a first brake pad assembly 130 having a friction member with a surface 131 and a second brake pad assembly 132 having a friction member with a surface 133. Surface 131 on the friction member of the first brake pad assembly 130 and surface 133 on the friction member of the second brake pad assembly 132 have complementary radial convex shapes with respect to braking surfaces 134a and 134b. The apex “A-A” for the radial concave shape and the radial convex shape, as best illustrated in FIGS. 4, is defined by an effective radius “R” of disc brake 110. The effective radius R represents a radial distance from the axis of rotation of rotor 134 which passes through the center of bore 20 in caliper 16 that retains actuation piston 36. The particular concave shape for braking surfaces 134a, 134b and particular convex shape 131,133 on the friction members are complementary and represent a curve or arc. While the radius of the curve or arc is not fixed, for this application, a radius of approximately 20 times the width “W” of the friction members of brake pad assembles 130,132 was selected.

FIG. 5 illustrates an alternate radial concave shape for the braking surfaces 140,142 for a rotor 234 and a complementary radial convex shape 141,143 for the friction members of brake pad assembles 130,132. In this embodiment, the curve is replaced with first and second linear slopes which extend from apex A-A toward the corresponding edges of the braking surfaces 140,142 for the rotor 234 and surfaces 141,143 for friction members of brake pad assembles 130,132. It is suggested that a linear slope should not be less than a ratio of one to twenty times the radial width W of the friction members of the first 130 and second 132 brake pad assembles and/or braking surfaces 141 and 143 on rotor 234.

### Mode of Operation

When an operator desires to effect a brake application for a vehicle equipt with disc brake 110, an input force from an operator is applied to a control and pressurized fluid is supplied through port 25 to actuation chamber 18 in bore 20. The pressurized fluid acts on actuation piston 36 to move surface 133 on friction member of brake pad assembly 132 into engagement with braking surface 134b on rotor 134 and acts on caliper 16 to move surface 131 on friction member of brake pad assembly 130 into engagement with braking surface 134a on the rotor 134 to develop a corresponding brake force. When surfaces 131,133 on friction members engage braking surfaces 134a,134b, a braking force F develops. The braking force F is transmitted by the leading edges 130a of brake pad assembles into support members 24 and since the convex shape of the friction members associated with brake pad assembles 130,132 are complementary with the concave shape of braking surface 134a,134b, the entire arcuate length of the friction member is maintained in engagement with the rotor along an arcuate plane normal to the effective radius R. With the trailing edges 130b retained in the arcuate plane by the concave and convex shapes, radial movement is eliminated or at least substantially reduced as the brake pad assembles 130,132 are self centered along the effective radius R and as a result noise or squeal is eliminated as vibration or radial movement does not occur.

The respective concave and complementary convex shapes for a rotor 134,234 and brake pad assembles 130,132 of disc brake 110 are effective in eliminating and/or reducing radial movement of the trailing edge of a friction member during a brake application. Whether an arcuate shape illustrated in FIG. 4 or a linear shape illustrated in FIG. 5 is used is a matter of choice but a smoother operation may be achieved with the arcuate shape illustrated in FIG. 4.

I claim:

1. A disc brake for use in a brake system of a vehicle, said disc brake having a first and second friction members which are moved to engagement with corresponding first and second braking surfaces on a rotor to retard the rotation of the rotor and effect a brake application for the vehicle, said disc brake being characterized by said first and second braking surfaces having a radial concave shape while said first and second friction members have a radial convex shape, said radial convex shape on engagement with said radial concave shape maintaining said first and second friction members in a substantially uniform location about an axis of rotation for said rotor.

2. The disc brake as recited in claim 1 wherein said first and second friction members each have a leading end and a trailing end on engagement with said corresponding first and second braking surfaces, said leading end of each of said first and second friction members transferring a braking force into a fixed support during a brake application with said trailing ends being free to move in a radial plane about said axis of rotation, said relationship defined between said radial convex and concave shapes retaining said trailing ends in said uniform location about said axis of rotation.

3. The disc brake as recited in claim 2 wherein said convex shape is complementary to said concave shape such that said first and second friction members substantially engage the entire first and second braking surfaces during a brake application.

4. A disc brake for use in a brake system of a vehicle, said disc brake having a first and second brake pads which are correspondingly moved into engagement with first and second braking surfaces on a rotor in response to hydraulic fluid being supplied to an actuation chamber in a housing to retard the rotation of the rotor and effect a brake application for the vehicle, said disc brake being characterized by said first and second braking surfaces on said rotor having a radial concave shape while said first and second brake pads each have a friction member with a radial convex shape, said radial convex shape being complementary to said radial concave shape such that on engagement during a brake application said first and second brake pads are retained in a substantially uniform arcuate location about an axis of rotation of said rotor.

5. The disc brake as recited in claim 4 wherein said radial concave shape on said first and second braking surfaces is defined by an apex which is normal to an effective radius for a piston retained in said actuation chamber.

6. The disc brake as recited in claim 5 wherein said concave shape on said first and second braking surfaces is defined by an arc having a radius which is not less than twenty times a radial width of said first and second braking surfaces.

7. The disc brake as recited in claim 4 wherein said concave shape on said first and second braking surfaces is defined by first and second linear slopes which meet at said apex, said slope being not less than a one to twenty ratio of a radial width of said first and second braking surfaces.
